(19) United States
(12) Patent Application Publication
(10) Pub. No.: US 2015/0155116 A1
(43) Pub. Date: Jun. 4, 2015

(54) MECHANICAL KEYBOARD AND METHOD FOR MOLDING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-MING XIAO, Shenzhen (CN)

(21) Appl. No.: 14/554,361

(22) Filed: Nov. 26, 2014

(30) Foreign Application Priority Data
Nov. 30, 2013 (CN) 201310622930.6

(51) Int. Cl. H01H 13/83; H01H 13/88

(52) U.S. Cl. CPC H01H 13/83; H01H 13/88; H01H 2219/036; H01H 2229/044

(57) ABSTRACT

A mechanical keyboard includes a base plate, a key assembly mounted on the base plate and a light source. The base plate defines a number of separate mounting holes therein. The key assembly includes a number of press keys. Each of the number of press keys is mounted in one of the number of mounting holes respectively. The press keys include a number of transparent portions. The transparent portions cooperatively form a decorative pattern. The light source is mounted in the base plate and located below the decorative pattern. Therein, the light source is used to transmit light through the at least one transparent portion, thereby illuminating the decorative pattern.

### FIELD

The subject matter herein generally relates to mechanical keyboards, especially to a mechanical keyboard with decorative pattern and a method for molding the mechanical keyboard.

### BACKGROUND

To increase beauty of a mechanical keyboard, one or more decorative patterns can be printed on the mechanical keyboard. However, the printed decorative patterns can be easily worn down and unclear, which decreases the beauty of the mechanical keyboard.

### BRIEF DESCRIPTION OF THE DRAWINGS

Many aspects of the present disclosure are better understood with reference to the follow drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a diagrammatic view of an embodiment of a mechanical keyboard.

FIG. 2 is a cross-sectional view of the electronic device shown in FIG. 1 taken along line II-II.

FIG. 3 is a flowchart of an embodiment of a method for molding the mechanical keyboard shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

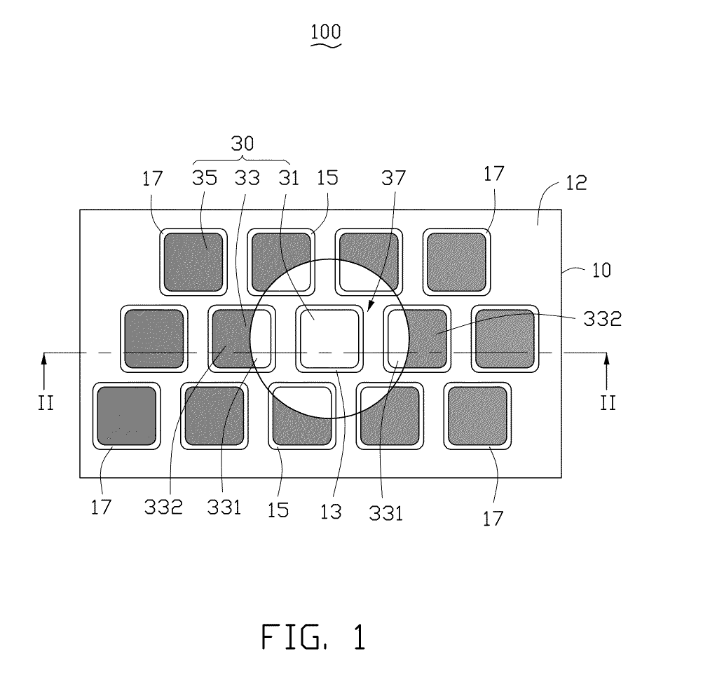

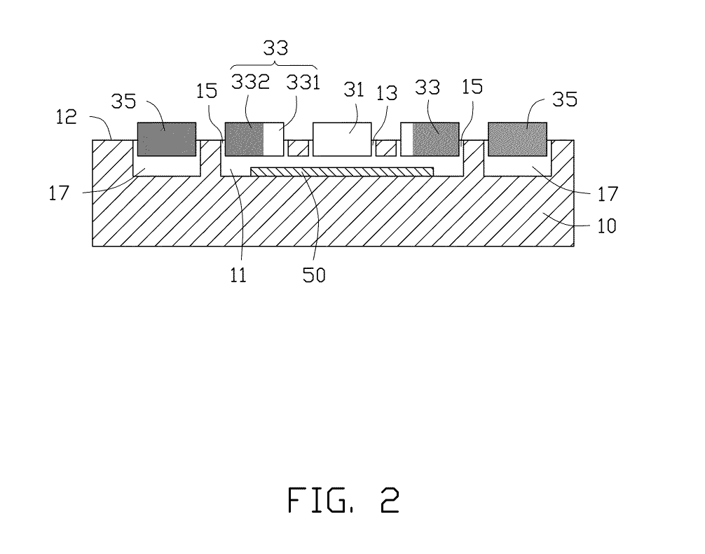

FIGS. 1 and 2 show a mechanical keyboard 100. The mechanical keyboard 100 can be an input device for a computer or a printer or the like. The mechanical keyboard 100 can include a base plate 10, a press assembly 30 mounted on the base plate 10 and a light source 50 mounted in the base plate 10. The mechanical keyboard 100 can also include other functional modules mounted in the base plate 10 to fulfill different functions; however, it is not shown and specifically described for simplification.

The base plate 10 can be made of non-transparent material. The base plate 10 can be substantially rectangular-shaped. The base plate 10 can define an accommodating space 11 therein. The base plate 10 can have an upper surface 12. The base plate 10 can further define a first mounting hole 13, a number of second mounting holes 15 and a number of third mounting holes 17 on the upper surface 12 separately. The first mounting hole 13 can be defined on a central region of the upper surface 12 of the base plate 10 and can be interconnected with the accommodating space 11. The second mounting holes 15 can be located around the first mounting hole 13 and can be interconnected with the first mounting hole 13. The third mounting holes 17 can be located around both the second mounting holes 15 and the first mounting hole 13 and can be disconnected with both the second mounting holes 15 and the first mounting hole 13.

The press assembly 30 can be located on the upper surface 12 of the base plate 10. The press assembly 30 can include a first press key 31, a number of second press keys 33 and a number of third press keys 35.

The first press key 31 can be mounted in the first mounting hole 13. The first press key 31 can be made by injection molding. The first press key 31 can be made of transparent material, thus, the first press key 31 can transmit light.

Each of the second press keys 33 can be mounted in one of the second mounting holes 15. Each of the second press keys 33 can include a transparent portion 331 and a non-transparent portion 332. The non-transparent portions 332 can be away from the first press key 31. The transparent portions 331 can be close to the first press key 31 and around the first press key 31. The second press key 33 can be made by two-shot molding. The transparent portion 331 can be made of transparent material such as transparent plastic or the like, thus, the transparent portion 331 can transmit light. The non-transparent portion 332 can be made of non-transparent material such as black plastic or the like, thus, the non-transparent portion 332 cannot transmit light. The number of the transparent portion 331 and the first press key 31 can cooperatively form a decorative pattern 37. In this embodiment, the decorative pattern 37 can be substantially circular.

Each of the third press keys 35 can be mounted in one of the third mounting holes 17. The third press keys 35 can be made by injection molding. The third press keys 35 can be made of non-transparent material such as black plastic or the like, thus, the third press keys 35 cannot transmit light. In this embodiment, the first press key 31, the second press keys 33 and the third press keys 35 can both have frosted surfaces, thus, the first press key 31, the second press keys 33 and the third press keys 35 can have enough frictional force to prevent slipping and further prevent the other functional modules below the decorative pattern 37 being shown on the decorative pattern 37.

The light source 50 can be mounted in the accommodating space 11 and located below the decorative pattern 37. When the mechanical keyboard 100 is electronically connected to an electronic device (not shown), the mechanical keyboard 100 can be charged with electricity, thus, the light source 50 can be used to transmit light through the first press key 31 and the at least one transparent portion 331 of the second press keys 33 to illuminated the decorative pattern 37.

In at least one embodiment, if the second press keys 33 can cooperatively form the desired decorative pattern 37, the first press key 31 can be omitted.

In at least one embodiment, if the first press key 31 and the second press key 33 can cooperatively form a desired keyboard, the third press keys 35 can be omitted.

In at least one embodiment, the first mounting hole 13 can be located on other locations on the base plate 10 according to the need.

In at least one embodiment, the decorative pattern 37 can be triangle-shaped, square-shaped, flower-shaped, apple-shaped, or the like.

In at least one embodiment, the number of the first mounting hole 13 can be zero, two, three, or the like.

In at least one embodiment, the number of the second mounting hole 15 can be zero, one, two, three, or the like.

In at least one embodiment, the number of the third mounting hole 17 can be zero, one, two, three, or the like.

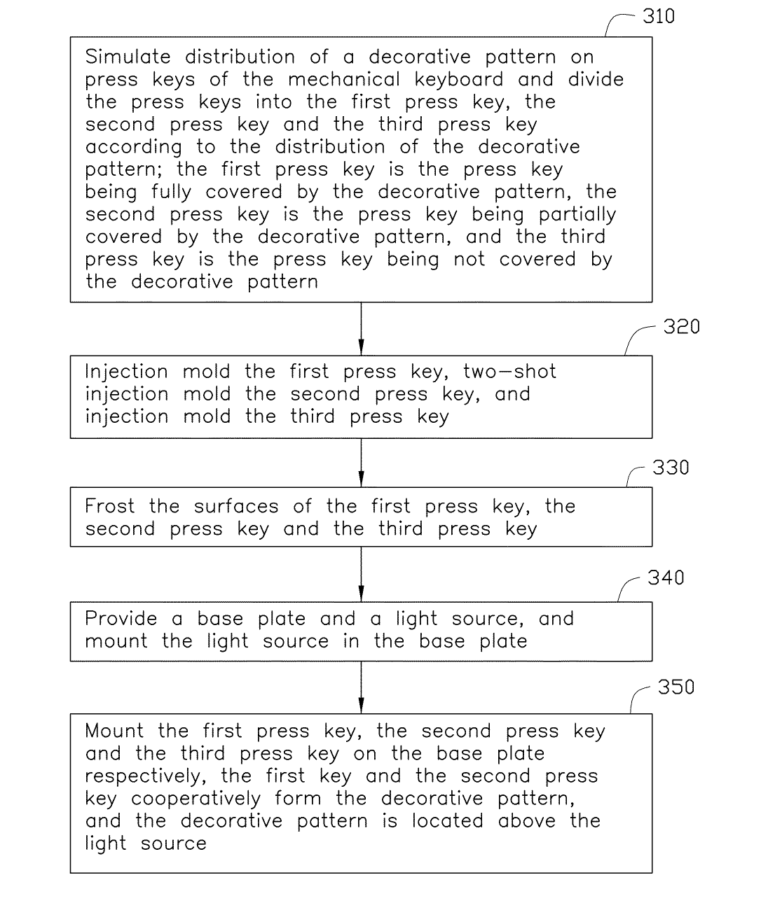

FIG. 3 shows a method for molding a mechanical keyboard. The method can include the following steps. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 310.

At block 310, simulate distribution of the decorative pattern on press keys of the mechanical keyboard and divide the press keys into the first press key, the second press key and the third press key according to the distribution of the decorative pattern, therein, the first press key can be the press key being fully covered by the decorative pattern, the second press key can be the press key being partially covered by the decorative pattern, and the third press key can be the press key being not covered by the decorative pattern.

At block 320, injection mold the first press key, two-shot injection mold the second press key, and injection mold the third press key.

At block 330, frost surface of the first press key, the second press key and the third press key.

At block 340, provide a base plate and a light source, and mount the light source in the base plate.

At block 350, mount the first press key, the second press key and the third press key on the base plate respectively, therein, the first key and the second press key can cooperatively form a decorative pattern, and the decorative pattern can be located above the light source.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A mechanical keyboard comprising:
a base plate having a plurality of separate mounting holes therein;
a press assembly comprising a plurality of press keys, each of the plurality of press keys being mounted in one of plurality of mounting holes respectively, the plurality of press keys comprising a plurality of transparent portions, and the plurality of transparent portions cooperatively forming a decorative pattern; and
a light source mounted in the base plate and located below the decorative pattern;
wherein, the light source is configured to transmit light through the at least one transparent portion, thereby illuminating the decorative pattern.

2. The mechanical keyboard of claim 1, wherein the plurality of mounting holes comprise at least one first mounting hole and a plurality of second mounting holes located around the at least one first mounting hole, the plurality of press keys comprises at least one first press key and a plurality of second press keys, each of the at least one first press key is mounted in one of the at least one first mounting hole, the at least one first press key is made of transparent material, each of the plurality of second press keys comprises the transparent portion and the transparent portion is made of transparent material, and each of the plurality of second press keys further comprises a non-transparent portion, and the non-transparent portion is made of non-transparent material, the at least one first press key and the plurality of transparent portions cooperatively form the decorative pattern.

3. The mechanical keyboard of claim 2, wherein the base plate defines an accommodating space therein, the accommodating space interconnects with the first mounting hole, and the first mounting hole interconnects with the plurality of second mounting holes, and the light source is accommodated in the accommodating space.

4. The mechanical keyboard of claim 3, wherein the plurality of mounting holes further comprise a plurality of third mounting holes located around both the plurality of second mounting holes and the at least one first mounting hole, and the plurality of third mounting holes disconnect with both the plurality of second mounting holes and the at least one first mounting hole; the plurality of press keys further comprise a plurality of third press keys, the plurality of third press keys is made of non-transparent material, each of the plurality of third press keys is mounted in one of the plurality of third mounting holes.

5. The mechanical keyboard of claim 1, wherein each of the plurality of press keys comprises a frosted surface.

6. The mechanical keyboard of claim 1, wherein the decorative pattern is triangle-shaped, circular, square-shaped, flower-shaped, or apple-shaped.

7. A method for molding a mechanical keyboard, comprising:
simulating distribution of a decorative pattern on a mechanical keyboard;
dividing the press keys into at least one first press key being fully covered by the decorative pattern and a plurality of second press keys being partially covered by the decorative pattern;
injection molding the at least one first press key, and two-shot injection molding the plurality of second press keys;
providing a base plate and a light source, and mounting the light source in the base plate; and
mounting the at least one first press key and the plurality of second press keys on the base plate to form the decorative pattern being located above the light source.

8. The method of claim 7, wherein the method further comprises:
dividing the press keys into a plurality of third press keys being not covered by the decorative pattern;
injection molding the plurality of third press keys; and
mounting the plurality of third press keys on the base plate around both the plurality of second press keys and the at least one first press key.

9. The method of claim 8, wherein the method further comprises:
frosting surface of the at least one first press key, the plurality of second press keys and the plurality of third press keys.
